(19) United States
(12) Patent Application Publication
(10) Pub. No.: US 2022/0084083 A1
(43) Pub. Date: Mar. 17, 2022

(54) METHOD AND SYSTEM FOR ONLINE ADAPTIVE PRICING IN RIDE-HAILING PLATFORMS

(71) Applicant: Beijing DiDi Infinity Technology and Development Co., Ltd., Beijing (CN)

(72) Inventors: Yanyi HE, Sunnyvale, CA (US); Liang TANG, Santa Clara, CA (US); Bo TAN, Sunnyvale, CA (US)

(21) Appl. No.: 17/018,223

(22) Filed: Sep. 11, 2020

(51) Int. Cl. G06Q 30/02; G06Q 10/06; G06Q 50/30; G06N 20/00

(52) U.S. Cl. CPC G06Q 30/0283; G06N 20/00; G06Q 50/30; G06Q 10/06393

(57) ABSTRACT

Methods, systems, and apparatus, including computer programs encoded on computer storage media, for determining price multipliers in a ride-hailing platform are described. An exemplary method may comprise: obtaining a price multiplier that has been applied in a pricing unit of the ride-hailing platform during a previous period of time and a key performance indicator (KPI) value of the pricing unit during the previous period of time; constructing a hash key; updating a hash table based on the KPI value and the hash key; determining whether to perform exploration or exploitation for a current period of time; when it is determined to perform exploration, selecting a new price multiplier; and when it is determined to perform exploitation: determining the new price multiplier based on one or more entries in the hash table to apply to the pricing unit for the current period of time.

### TECHNICAL FIELD

The disclosure relates generally to systems and methods for online adaptive pricing in ride-hailing platforms, and in particular, using online data to determine adaptive price multipliers through reinforcement learning (RL) in a ride-hailing environment.

### BACKGROUND

On-demand ride-hailing services have seen rapid expansion in recent years. In a ride-hailing platform, the rider price is an “upfront” price, which factors in estimated travel time and distance, supply/demand balance (e.g., as surge multipliers), price adjustment multipliers, and various surcharges and fees. The price adjustment multiplier is one key component of the rider pricing strategy and is usually determined based on objective factors like consumer price sensitivity and carpool match rates, or even subjective opinions. The state-of-the-art solutions to determine price adjustment multipliers are generally based on models trained offline. Unfortunately, these modules are not sufficiently flexible or adaptive to the changing market. Thus, it is desirable to provide an online adaptive pricing method for ride-hailing platforms.

### SUMMARY

Various embodiments of the present specification may include systems, methods, and non-transitory computer-readable media for determining adaptive price multipliers in ride-hailing platforms.

According to one aspect, the method for determining price multipliers may comprise obtaining a price multiplier that has been applied in a pricing unit of the ride-hailing platform during a previous period of time and a key performance indicator (KPI) value of the pricing unit during the previous period of time; constructing a hash key based on (1) an identifier of the pricing unit and (2) the price multiplier; updating a hash table based on the KPI value and the hash key; determining whether to perform exploration or exploitation for a current period of time; when it is determined to perform exploration, selecting a new price multiplier from a list of price multiplier candidates to apply to the pricing unit for the current period of time; and when it is determined to perform exploitation: determining the new price multiplier based on one or more entries in the hash table to apply to the pricing unit for the current period of time, wherein the one or more entries correspond to one or more price multipliers that have been previously applied to the pricing unit.

In some embodiments, the determining the new price multiplier based on one or more entries in the hash table comprises: identifying one of the one or more entries with the highest KPI value, wherein the one entry corresponds to an optimal price multiplier; and determining the optimal price multiplier as the new price multiplier.

In some embodiments, the KPI value comprises a weighted sum of one or more KPI metrics measured based on interaction sessions between riders and the ride-hailing platform that occurred in the pricing unit during the previous period of time.

In some embodiments, the one or more KPI metrics comprise at least one of the following: a trip conversion rate metric, a gross profit metric, a net income metric, a gross merchandise value (GMV) metric, or a gross booking metric.

In some embodiments, the updating a hash table comprises: determining whether the hash key exists in the hash table; when the hash key does not exist in the hash table, adding a new entry comprising the hash key and the KPI value into the hash table; and when the hash key exists in the hash table and corresponds to an existing KPI value, updating the existing KPI value based on the KPI value and a KPI decay rate.

In some embodiments, the updating the existing KPI value based on the KPI value and a KPI decay rate comprises: determining a new KPI value based on a sum of (1) a first product of the existing KPI value and the KPI decay rate and (2) a second product of the KPI value and a complement of KPI decay rate; and replacing the existing KPI value with the new KPI value.

In some embodiments, the selecting a new price multiplier from a list of price multiplier candidates to apply to the pricing unit for the current period of time comprises: determining whether a difference between the new price multiplier and the price multiplier is greater than a threshold; and when the difference is greater than the threshold, randomly selecting another new price multiplier from the list of price multiplier candidates.

In some embodiments, the determining whether to perform exploration or exploitation for a current period of time comprises: determining whether to perform exploration or exploitation for a current period of time based on a randomly generated number and an exploration rate.

In some embodiments, the method may further comprise: when it is determined to perform exploitation, updating the exploration rate based on the determined new price multiplier.

In some embodiments, the updating the exploration rate comprises: determining whether the new price multiplier is the same as a previous price multiplier that has been applied in the pricing unit during a most recent period time in which exploitation was performed; if the new price multiplier is the same as the previous price multiplier, adjusting the exploration rate based at least on an exploration decay rate; and if the new price multiplier is not the same as the previous price multiplier, resetting the exploration rate to a default value.

In some embodiments, the method may further comprise: adjusting a length of the current period of time.

In some embodiments, the method may further comprise: for a newly created pricing unit to which no price multiplier has applied, determining the new price multiplier with a default value.

According to another aspect, a system comprising one or more processors and one or more non-transitory computer-readable memories coupled to the one or more processors, the one or more non-transitory computer-readable memories storing instructions that, when executed by the one or more processors, cause the system to perform operations comprising: obtaining a price multiplier that has been applied in a pricing unit of the ride-hailing platform during a previous period of time and a key performance indicator (KPI) value of the pricing unit during the previous period of time; constructing a hash key based on (1) an identifier of the pricing unit and (2) the price multiplier; updating a hash table based on the KPI value and the hash key; determining whether to perform exploration or exploitation for a current period of time; when it is determined to perform exploration, selecting a new price multiplier from a list of price multiplier candidates to apply to the pricing unit for the current period of time; and when it is determined to perform exploitation: determining the new price multiplier based on one or more entries in the hash table to apply to the pricing unit for the current period of time, wherein the one or more entries correspond to one or more price multipliers that have been previously applied to the pricing unit.

According to yet another aspect, a non-transitory computer-readable storage medium storing instructions that, when executed by one or more processors, cause the one or more processors to perform operations comprising: obtaining a price multiplier that has been applied in a pricing unit of the ride-hailing platform during a previous period of time and a key performance indicator (KPI) value of the pricing unit during the previous period of time; constructing a hash key based on (1) an identifier of the pricing unit and (2) the price multiplier; updating a hash table based on the KPI value and the hash key; determining whether to perform exploration or exploitation for a current period of time; when it is determined to perform exploration, selecting a new price multiplier from a list of price multiplier candidates to apply to the pricing unit for the current period of time; and when it is determined to perform exploitation: determining the new price multiplier based on one or more entries in the hash table to apply to the pricing unit for the current period of time, wherein the one or more entries correspond to one or more price multipliers that have been previously applied to the pricing unit.

These and other features of the systems, methods, and non-transitory computer-readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 illustrates an exemplary system to which online adaptive price multiplier determination in a ride-hailing platform may be applied, in accordance with various embodiments.

FIG. 2 illustrates an exemplary chart of online adaptive price multiplier determination in a ride-hailing platform in accordance with various embodiments.

FIG. 3 illustrates an exemplary hash table storing historically applied price multipliers and corresponding KPI values, in accordance with some embodiments.

FIG. 4 illustrates an exemplary flow chart of a method for online adaptive price multiplier determination in a ride-hailing platform in accordance with various embodiments.

FIG. 5 illustrates an exemplary method for online adaptive price multiplier determination in a ride-hailing platform in accordance with various embodiments.

FIG. 6 illustrates a block diagram of a computer system in which any of the embodiments described herein may be implemented.

### DETAILED DESCRIPTION

Specific, non-limiting embodiments of the present invention will now be described with reference to the drawings. It should be understood that particular features and aspects of any embodiment disclosed herein may be used and/or combined with particular features and aspects of any other embodiment disclosed herein. It should also be understood that such embodiments are by way of example and are merely illustrative of a small number of embodiments within the scope of the present invention. Various changes and modifications obvious to one skilled in the art to which the present invention pertains are deemed to be within the spirit, scope, and contemplation of the present invention as further defined in the appended claims.

The price adjustment multiplier (also called price multiplier) is one of the key components for a ride-hailing platform to determine prices for its ride-sharing trips. The ride-hailing platform may assign a plurality of price multipliers to a plurality of pricing units. Trips that occurred within one pricing unit may be applied with the corresponding price multiplier. In the context of ride-sharing services, a pricing unit may refer to a spatial-temporal cluster (e.g., a location during a specific period of time), a route-temporal cluster (e.g., a specific pair of pick-up location and drop-off location during a specific period of time), or another suitable cluster. The pricing unit may be associated with one or more spatial and/or temporal conditions. When a trip, an order, or an interaction session between a rider and the ride-sharing platform satisfies the one or more conditions, it belongs to the pricing unit and may be priced based on various pricing factors that are associated with the pricing unit, such as the price multiplier of the pricing unit. The pricing units may be determined based on, for example, spatial-temporal clustering algorithms, empirical evidence, or rule-based methods. In some embodiments, the price multiplier assigned to a pricing unit may need to be adjusted according to a change of circumstances (e.g., some of them may be drastic) within the pricing unit, such as weather changes, new pricing strategies from competitors, new events, demand-supply imbalance, or other suitable changes. However, state-of-the-art solutions are generally based on models that are trained using offline data, and the models may be unable to capture the changes and react promptly. The delayed adjustments to the price multipliers may lead to degradation of the financial and growth performance of the ride-hailing platform.

This specification discloses methods, systems, and storage medium of an online adaptive price multiplier determination based on reinforcement learning (RL). In some embodiments, the RL algorithm refers to a multi-armed bandit model. In probability theory, the multi-armed bandit problem is a problem in which a fixed limited set of resources must be allocated between competing (alternative) choices in a way that maximizes their expected gain. Each choice's properties are only partially known at the time of allocation and may become better understood as time passes or by allocating resources to the choice. The key problem in the multi-armed bandit problem is the exploration-exploitation tradeoff, which is the tradeoff between “exploitation” of the choice that has the highest expected gain and “exploration” to get more information about the expected gains of the other choices. During the process of learning the optimal price multiplier assignment strategy, different price multipliers may be referred to as the competing choices to make.

In some embodiments, each price multiplier in a pricing unit is associated with a reward distribution at a certain time interval τ. The objective is to learn a reward distribution from the previous time interval τ, and determine the optimal price multiplier for the pricing unit in the next time interval τ. In some embodiments, the lengths of the time intervals may be adjusted. The “optimal” in this context may refer to maximizing a system-level (e.g., across all the pricing units) reward to the ride-hailing platform. For example, the reward may include one or more key performance indicators (KPI), such as a trip conversion rate metric, a gross profit metric, a net income metric, a gross merchandise value (GMV) metric, or a gross booking metric, or any combination thereof. When there are multiple KPI metrics are considered, the system-level reward may refer to a weighted sum of the KPI metrics. The above description may be illustrated as a formula (1):

R=Σ_{τ,u}w^{T}x_{τ,u} (1)

where w^{T} refers to a vector of weights corresponding to a vector of KPI metrics, x_{τ,u} is the vector of KPI metrics, τ refers to a time interval, u refers to a pricing unit, and R refers to the reward to be maximized. The value of x_{τ,u} may be affected by the price multiplier applied in the pricing unit u during time interval τ. The embodiments disclosed herein illustrate how the price multipliers may be determined for the pricing units using reinforcement learning.

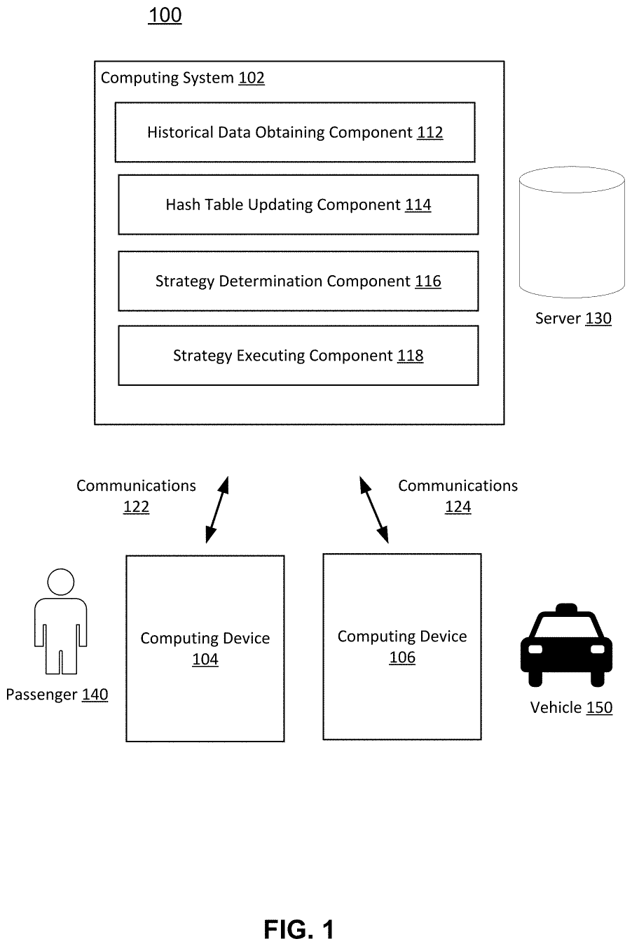

FIG. 1 illustrates an exemplary system 100 to which online adaptive price multiplier determination in a ride-hailing platform may be applied, in accordance with various embodiments. The exemplary system 100 may include a computing system 102, a computing device 104, and a computing device 106. It is to be understood that although two computing devices are shown in FIG. 1, any number of computing devices may be included in the system 100. Computing system 102 may be implemented in one or more networks (e.g., enterprise networks), one or more endpoints, one or more servers, or one or more clouds. A server may include hardware or software which manages access to a centralized resource or service in a network. A cloud may include a cluster of servers and other devices that are distributed across a network.

The computing devices 104 and 106 may be implemented on or as various devices such as a mobile phone, tablet, server, desktop computer, laptop computer, vehicle (e.g., car, truck, boat, train, autonomous vehicle, electric scooter, electric bike), etc. The computing system 102 may communicate with the computing devices 104 and 106, and other computing devices. Computing devices 104 and 106 may communicate with each other through computing system 102, and may communicate with each other directly. Communication between devices may occur over the internet, through a local network (e.g., LAN), or through direct communication (e.g., BLUETOOTH™, radio frequency, infrared).

In some embodiments, the system 100 may include a ride-hailing platform. The ride-hailing platform may facilitate transportation service by connecting drivers of vehicles with passengers. The platform may accept requests for transportation from passengers, identify idle vehicles to fulfill the requests, arrange for pick-ups, and process transactions. For example, passenger 140 may use the computing device 104 to order a trip. The trip order may be included in communications 122. The computing device 104 may be installed with a software application, a web application, an API, or another suitable interface associated with the ride-hailing platform.

While the computing system 102 is shown in FIG. 1 as a single entity, this is merely for ease of reference and is not meant to be limiting. One or more components or one or more functionalities of the computing system 102 described herein may be implemented in a single computing device or multiple computing devices. In some embodiments, the computing system 102 may comprise various components, such as a historical data obtaining component 112, a hash table updating component 114, a strategy determination component 116, and a strategy execution component 118.

In some embodiments, the historical data obtaining component 112 may be configured to obtain a price multiplier that has been applied in a pricing unit of the ride-hailing platform during a previous period of time and a key performance indicator (KPI) value of the pricing unit during the previous period of time. For example, the KPI value may refer to a number of trips within the pricing unit during the past 12 hours. In some embodiments, the length of the period (also called a time interval) may be adjusted based on needs, such as 10 minutes, 1 hour, 12 hours, or a day. In some embodiments, the KPI may include at least one of the following: a number of trips, a trip conversion rate metric, a gross profit metric, a net income metric, a gross merchandise value metric, a gross booking metric, or a weighted sum of any combination thereof.

In some embodiments, the price multipliers applied to a plurality of pricing units, the KPI values generated from the pricing units. or other types of online data may be generated by the ride-hailing platform continuously (e.g., whenever a price query or a ride request occurs). These continuous data may be processed and aggregated based on time interval length and the pricing units to be used by the other components of the computing system 102. That is, the historical data may be collected in small batches, rather than in a per-request manner.

In some embodiments, besides the price multiplier and the KPI value, the collected historical data may also include the pricing unit information, the interaction logs between a rider and the ride-hailing platform, and other suitable information.

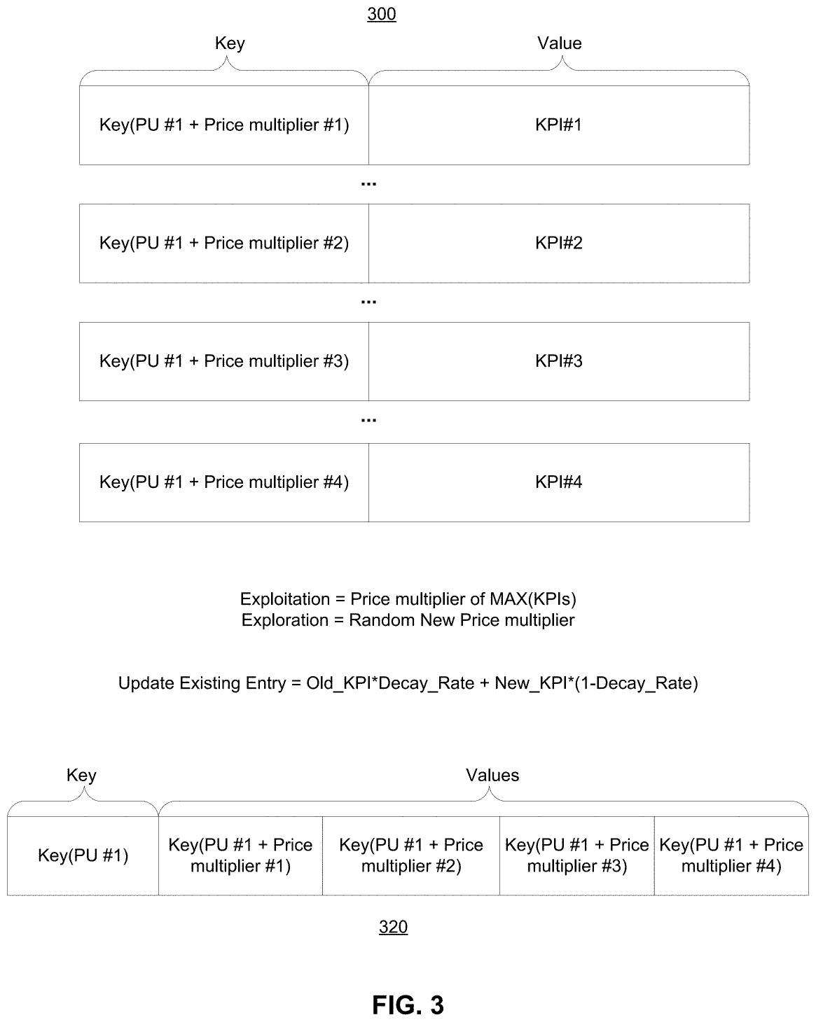

In some embodiments, the hash table updating component 114 may be configured to update a hash table based on the KPI value and a hash key, where the hash key may be constructed based on (1) an identifier of the pricing unit and (2) the price multiplier. The hash table updating component 114 may be further configured to create and initialize the hash table. In some embodiments, the hash table may be configured to store key-value pairs, where the hash key is determined by a combination of pricing unit information (e.g., an identifier of the pricing unit) and a price multiplier applied to the pricing unit, and the value includes the corresponding KPI value (e.g., the KPI value received by the ride-hailing platform after applying the price multiplier to the pricing unit for a period). When a new key-value pair is to be added, the hash table may determine whether there is an existing entry corresponding to the same key. If there is no existing entry corresponding to the same key, the new key-value pair may be added to the hash table directly. If there is an existing entry corresponding to the same key, the value of the existing entry may be updated based on the new value and a decay rate. More details about the hash table updating process may be referred to the description of FIG. 3.

In some embodiments, the strategy determination component 116 may be configured to determine whether to perform exploration or exploitation for a current period of time. In some embodiment, the determination is made based on a randomly generated number and an exploration rate. The exploration rate may refer to a value indicating the probability of performing an exploration operation in the current period. Here, the exploration is opposite to exploitation, where exploration involves a certain degree of randomness in determining the price multiplier for the pricing unit in the current period, and exploitation involves determining the price multiplier for the pricing unit in the current period based on the information has been collected and learned. In some embodiments, the exploration rate may be fixed or adjustable. In some embodiments, the exploration rate may be adjusted based on the actions that have been taken during the previous periods. In some embodiments, the strategy determination component 116 may generate a random number within a range of possible values of the exploration rate for each of the plurality of pricing units, and determine whether the random number is greater than the exploration rate. If the random number is not greater than the exploration rate, exploration may be performed; otherwise, exploitation may be performed. In some embodiments, the range of the random number and the range of the decay rate may be the same, e.g., both are floating numbers between 0 and 1.

In some embodiments, the strategy executing component 118 may be configured to perform the exploration or exploitation in a pricing unit for the current period. For example, when it is determined to perform exploration, a new price multiplier may be randomly selected from a list of price multiplier candidates to apply to the pricing unit for the current period. When it is determined to perform exploitation, the new price multiplier to apply to the pricing unit for the current period may be determined based on one or more entries in the hash table, wherein the entries correspond to one or more price multipliers that have been previously applied to the pricing unit. These entries may have hash keys that were constructed at least partially based on the identifier of the pricing unit, and respectively correspond to historical price multipliers that have been previously applied to the pricing unit. In some embodiments, the new price multiplier may be equal to one of the historical price multipliers that achieved the highest KPI value.

In some embodiments, when it is determined to perform exploration, the randomly selected price multiplier may be further screened based on a deviation threshold. For example, if a difference between the randomly selected price multiplier and the previous price multiplier (e.g., the one applied to the pricing unit during the previous period) is greater than a deviation threshold, a new price multiplier may be randomly selected. The purpose of this screening is to make sure that the new price multiplier does not deviate from the previous one by a large margin, which may introduce price instability.

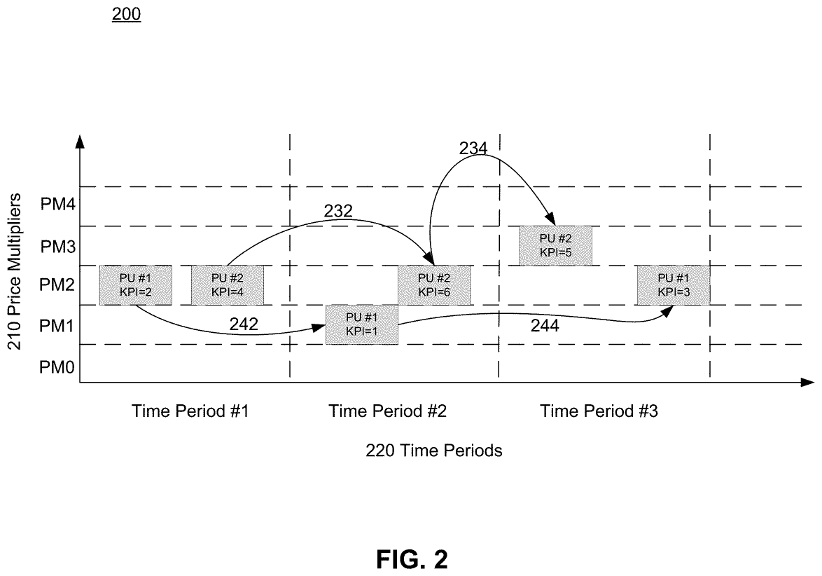

FIG. 2 illustrates an exemplary chart 200 of online adaptive price multiplier determination in a ride-hailing platform in accordance with various embodiments. The chart 200 in FIG. 2 includes a vertical axis representing a list of price multiplier candidates 210, and a horizontal axis representing a plurality of periods (e.g., time intervals) 220. Two pricing units PU #1 and PU #2 are included in chart 200 for illustration purposes. The list of price multiplier candidates 210 may be determined by the ride-hailing platform as a plurality of discrete values. In some embodiments, the list of price multiplier candidates 210 may be replaced by a continuous range from which valid price multipliers may be selected.

In the chart 200, the first period (e.g., time period #1) is presumed to be a genesis period of the price multiplier determination process that has no historical information. During this period, both pricing units (PU #1 and PU #2) may be initialized to have the same price multiplier (e.g., PM2). In some embodiments, the initialization may assign default price multipliers to a new pricing unit. In other embodiments, the initialization may assign random price multipliers to the new pricing unit.

Once a price multiplier is applied (or assigned) to a pricing unit, ride requests and trips that fall into the pricing unit may use the price multiplier in determining prices. The determined prices are directly related to the KPI values (e.g., rewards) that the ride-hailing platform may gain from each pricing unit. In FIG. 2, during time period #1, PU #1 generates KPI value as 2, and PU #1 generates KPI value as 4.

During the second period (e.g., time period #2), a new price multiplier may be determined for each of the pricing units by either exploration or exploitation. The exploration and exploitation choices establish the RL framework for determining the adaptive optimal price multipliers for the pricing units. In some embodiments, each choice between exploration and exploitation may be determined based on a randomly generated number and an evolving exploration rate (e.g., a probability to perform exploration for the current period). As shown in FIG. 2, the new price multiplier in PU #1 during time period #2 is determined by exploration 242. During exploration 242, the new price multiplier may be randomly selected from the price multiplier candidates (e.g., PM0˜PM4 in chart 200) without considering the historical data, such as what price multipliers have been applied in the past and what KPI values have been generated. In the example shown in FIG. 2, the new price multiplier for PU #1 during time period #2 is randomly determined as PM1, which makes PU #1 generate a KPI value as 1 during time period #2.

In comparison, the new price multiplier in PU #2 during time period #2 is determined by exploitation 232. During exploitation 232, historically applied price multipliers in the pricing unit and their corresponding KPI values may be considered (retrieved from the hash table). For example, only price multiplier PM2 has been applied to PU #2 previously and yielded a corresponding KPI value of 4 (shown in FIG. 2) during the same period. In some embodiments, the historical multiplier that makes the pricing unit generate the highest KPI may be selected as the new price multiplier for the next period.

During the third period (time period #3), the chart 200 shows that the new price multiplier in PU #1 is determined by exploitation 244, and the new price multiplier in PU #2 is determined by exploration 234. The exploration 234 is similar to the exploration 242. During the exploitation 244 process, the previously applied price multipliers in PU #1 include PM2 during the time period #1 and PM1 during time period #2, the corresponding KPI values are 2 and 1 respectively. Based on the historical KPI values, the price multiplier led to the highest KPI value may be selected as the new price multiplier for PU #1 during the time period #3. In this case, PM2 is selected. The historically applied price multipliers and corresponding KPI values for each pricing unit are stored in a hash table, as illustrated in FIG. 3.

FIG. 3 illustrates an exemplary hash table 300 storing historically applied price multipliers and corresponding KPI values, in accordance with some embodiments. The hash table may maintain a plurality of entries, with each corresponding to a specific price multiplier applied to a specific pricing unit. The hash table 300 may be configured to store entries such as key-value pairs. The hash key for each entry in the hash table 300 may be determined by applying a hash algorithm to various factors, such as the identifier of the pricing unit, the price multiplier applied to the pricing unit, and other suitable factors. In some embodiments, the value for each entry in the hash table 300 may include the KPI value obtained by the pricing unit during a period with the price multiplier applied, the price multiplier applied to the pricing unit, or another suitable value. This way, each of the entries in the hash table 300 corresponds to a unique combination of a pricing unit and a price multiplier applied to the pricing unit at some point in the history. In some embodiments, if a same price multiplier has been applied to a same pricing unit for multiple times, the hash table may still keep one entry for this combination, with the value being calculated based on all the KPI values that have achieved by the applications of the same price multiplier.

In FIG. 3, one pricing unit (PU #1) and its related hash table entries are shown for illustrative purposes. For example, by denoting Key( ) as the hash function, the pricing unit PU #1 corresponds to four entries in the hash table with hash keys as Key(PU #1, Price multiplier #1), Key(PU #1, Price multiplier #2), Key(PU #1, Price multiplier #3), and Key(PU #1, Price multiplier #4), and with values as the corresponding KPI values (e.g., KPI #1˜KPI #4).

In some embodiments, the hash table 300 may be consulted to determine the price multipliers of the pricing units for a new period. As described above, the new price multiplier of a pricing unit may be determined by exploration or exploitation. In some embodiments, during exploration, the new price multiplier may be randomly selected from the price multiplier candidates without consulting the hash table 300. During exploitation, the new price multiplier may be determined based on the historical data stored in the hash table. For example, the new price multiplier for pricing unit PU #1 may be determined by: retrieving all entries in the hash table 300 that correspond to PU #1, determining one of the entries with the highest KPI value and the corresponding price multiplier; and selecting the corresponding price multiplier as the new multiplier. Here, “all entries in the hash table 300 that correspond to PU #1” may refer to the entries corresponding to the price multipliers that have been applied to the pricing unit in the past. These entries may have hash keys constructed based partially on the identifier of the pricing unit.

In some embodiments, the hash table 300 may be updated by adding new entries or updating existing entries. In some embodiments, when a price multiplier is applied to a pricing unit (e.g., through exploration, or at initialization) for the first time, a new entry may be added to the hash table 300. The new entry may comprise a hash key and a value, the hash key being a hash value computed based on the price multiplier (e.g., the identifier/index of the price multiplier, or the value of the price multiplier) and an identifier of the pricing unit, and the value being the KPI value generated by the pricing unit after applying the price multiplier for a period. If a price multiplier has been applied to a pricing unit previously, the hash table may have an existing entry corresponding to the combination of the price multiplier and the pricing unit. In some embodiments, the existing entry may be updated based on the existing KPI value (in the existing entry) and the new KPI value generated by the pricing unit after applying the new price multiplier. A decay rate may be used to perform the update. For example, the value of the existing entry in the hash table 300 may be updated as existing_KPI*decay_rate+new_KPI*(1−decay_Rate), where the decay_rate is presumed to be a floating number (percentage) between zero and one.

In some embodiments, in addition to the hash table described above (denoted as the first hash table), a second hash table 320 may be necessary for quickly locating the entries in the first hash table. For example, the first hash table may only support efficient lookups based on hash keys constructed from both (1) the identifier of a pricing unit and (2) a price multiplier that has applied to the pricing unit. However, it may not support efficient lookup for all the entries corresponding to the pricing unit. For example, the first hash table may not support a lookup based on a hash key constructed solely from the identifier of the pricing unit. In some embodiments, a second hash table 320 may be constructed to maintain a mapping relationship between “the identifier of the pricing unit” and all the hash keys constructed from both (1) the identifier of the pricing unit and (2) the price multipliers that have applied to the pricing unit. As shown in FIG. 3, the second hash table 320 has one entry with a key and multiple values, where the key is computed based on PU #1 (the identifier), and the multiple values include the four hash values in the first hash table that are constructed at least partially based on PU #1. This way, by looking up the second hash table 320 based on the identifier of PU #1, all the hash keys of the first hash table 300 that corresponding to PU #1 may be obtained. Subsequently, the hash keys may be used to look up the first hash table 300 for the corresponding KPI values.

In some embodiments, the second hash table 320 may be constructed by: when a first hash key constructed base on (1) the identifier of the pricing unit and (2) the price multiplier applied to the pricing unit, determining whether the first hash key exists in the first hash table; if the first hash key does not exist in the first hash table, constructing a second hash key based on the identifier of the pricing unit, and a key-value pair with the second hash key as key and the first hash key as value; adding the key-value pair to the second hash table. The presence of the second hash table may provide constant-time lookups for entries that are associated with one particular pricing unit. With only the first hash table, the time complexity for these lookups may be linear time.

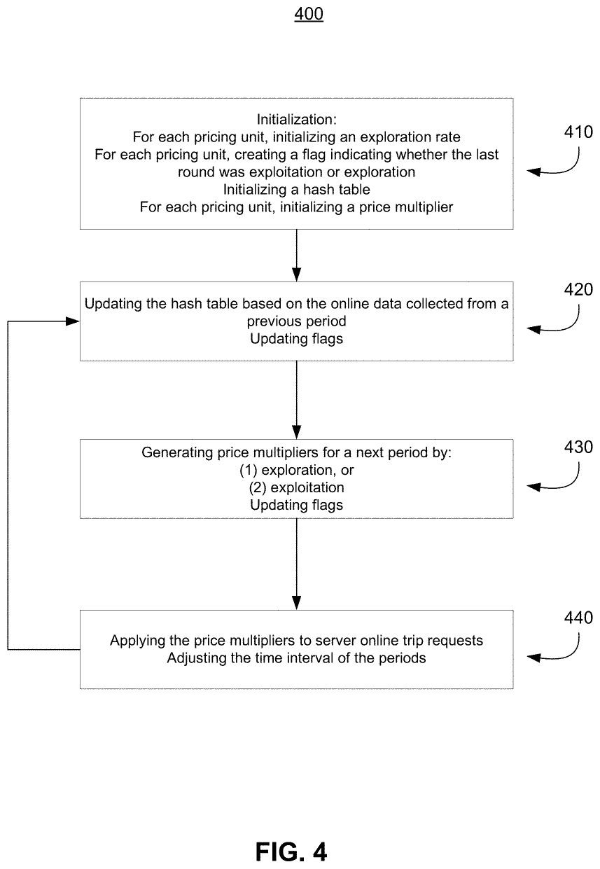

FIG. 4 illustrates an exemplary flow chart of a method 400 for online adaptive price multiplier determination in a ride-hailing platform in accordance with various embodiments. The method 400 is merely illustrative. Depending on the implementation, the method 400 may have more, fewer, or alternative steps or components. The method 400 may be implemented by the computing system 102 in FIG. 1.

In some embodiments, before the method 400 may be executed, various parameters may be configured first, such as the weights w^{T} in formula (1), an initial exploration probability pᵢₙᵢₜᵢₐₗ, an exploration decay rate λ, a minimal exploration probability pₘᵢₙ, a default price multiplier m_{default}, a decay rate β for KPI metrics in the moving average, a list of price multiplier candidates M, another suitable parameter, or any combination thereof.

In some embodiments, method 400 may include an initialization step 410. During this step, each of the pricing units of the ride-hailing platform (denoted as u) may be initialized by: setting an evolving (e.g., adjustable) exploration rate as pᵤ:=pᵢₙᵢₜᵢₐₗ, and creating a boolean variable last_round_exploredᵤ: =false. This boolean variable will record whether the price multiplier was determined by “exploitation” or “exploration” during the previous period. Furthermore, a hash table S (e.g., the hash table 300 in FIG. 3) may be initialized to be empty. The hash key of an entry in S may be determined by a combination of pricing unit u and the price multiplier m, e.g., (u, m), and the value of the entry is determined based on the key metrics used in formula (1), e.g., w^{T}x_{τ,u}. In some embodiments, the price multiplier mᵤ for each pricing unit u may be initialized to a default multiplier m_{default}. These initialized values may be deployed to serve online traffics in the ride-hailing platform to collect online data for a period.

After the online data has been collected from the previous period, step 420 may be performed to update the hash table S and other parameters. In some embodiments, the hash table S may be updated. For example, if (u, mᵤ) exists in S, updating S(u, mᵤ): =βS(u, mᵤ)+(1−β)xᵤ, where β refers to the decay rate; otherwise, adding S(u, mᵤ): =xᵤ. In some embodiments, a flag m_{u,pre}: =mᵤ may be created or updated to record the previous multiplier. In some embodiments, if last_round_exploredᵤ=false (i.e., exploitation was performed during the previous period), the previous optimal multiplier should be stored as m_{u,optimal}: =mᵤ.

Once the updates are done in step 420, a new price multiplier may be determined for each of the pricing units in the ride-hailing platform in step 430. In some embodiments, a random number randᵤ between 0 and 1 (with uniform distribution) may be generated for each pricing unit u. If randᵤ≤pᵤ, where pᵤ refers to the evolving exploration rate, a new price multiplier may be explored. The new price multiplier for pricing unit u may be randomly selected from the price multiplier list M. In some embodiments, an additional check may be performed so that the new price multiplier does not vary from the previous multiplier more than a threshold. For example, the additional check may be “if |mᵤ−m_{u,pre}|<ξ”, where mᵤ refers to the randomly selected new price multiplier, and ξ is the maximum multiplier variance. If the additional check finds the variance is greater than the threshold, another price multiplier may be randomly selected from the list M. After the exploration of the new price multiplier, a parameter update may be performed: last_round_exploredᵤ: =true, which means “exploration” has been executed.

If randᵤ>pᵤ, the new price multiplier may be exploited based on historical data stored in the hash table S. For a given pricing unit u, all the entries in the hash table S corresponding to historical price multipliers that have been applied to the pricing unit u may be retrieved. Each of these entries may include a KPI value reflecting the reward obtained by the pricing unit u after applying the corresponding price multiplier for one or more time intervals. In some embodiments, the price multiplier corresponding to the highest KPI value may be selected as the new price multiplier. In some embodiments, a minimum threshold for the KPI value may be enforced. For example, if the highest KPI value from the hash table S fails to meet the minimum threshold, it means all previously applied price multipliers fail to yield reasonably good rewards. In this case, the exploitation may be converted to exploration, e.g., by randomly selecting a price multiplier from the list M, or the list M excluding the previously applied price multipliers.

In some embodiments, after the exploitation is executed, the exploration probability pᵤ may be updated. For example, if mᵤ=m_{u,optimal} (e.g., the new price multiplier is the same as the previous optimal multiplier), the pᵤ may be updated as max(pₘᵢₙ, λpᵤ), where λ is the exploration decay rate. It means, if the optimal price multiplier for the pricing unit u starts to converge, the exploration rate may be reduced, but not less than the pₘᵢₙ. If mᵤ is different from m_{u,optimal}, the exploration rate may be reset back to the default, e.g., pᵤ=pᵢₙᵢₜᵢₐₗ.

In some embodiments, if the exploitation is performed for this around (e.g., for the current period), the corresponding flag may be updated, e.g., last_round_exploredᵤ: =false.

Once the new price multipliers are determined for all the pricing units for the current period, the ride-hailing platform may deploy these price multipliers to serve online trip requests and rides at step 440. In some embodiments, the length of the time interval may be adjusted at step 440. After deploying the price multipliers for a period, new online data may be collected, and the method 400 may repeat itself from step 420 to determine new price multipliers for the current period.

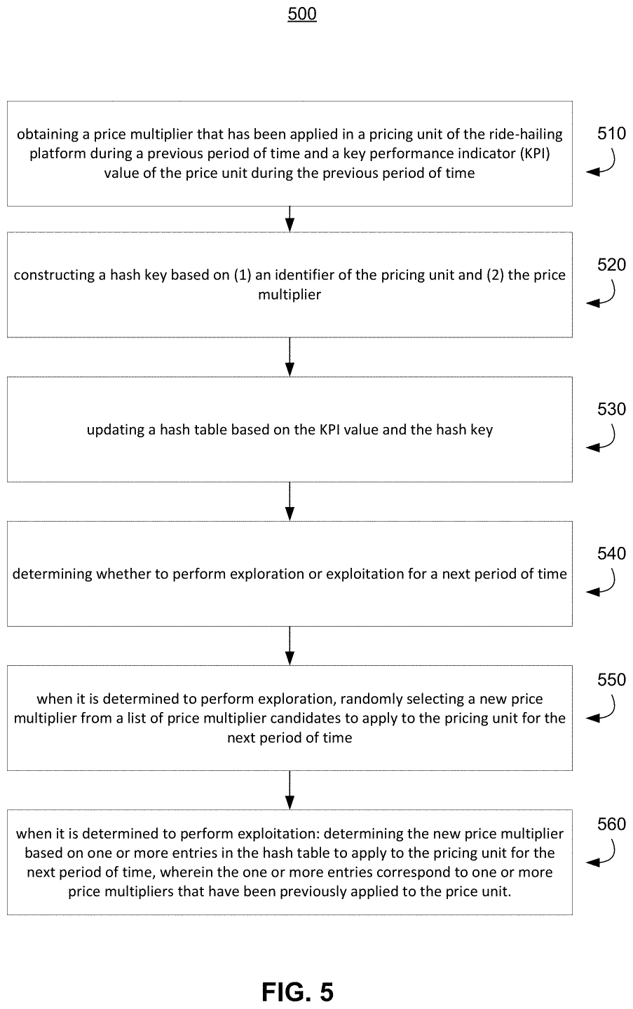

FIG. 5 illustrates an exemplary method 500 for detecting malicious activities in a ride-hailing platform in accordance with various embodiments. The method 500 may be implemented in an environment shown in FIG. 1. The method 500 may be performed by a device, apparatus, or system illustrated by FIGS. 1-4, such as the system 102. Depending on the implementation, the method 500 may include additional, fewer, or alternative steps performed in various orders or in parallel.

Block 510 includes obtaining a price multiplier that has been applied in a pricing unit of the ride-hailing platform during a previous period of time and a key performance indicator (KPI) value of the pricing unit during the previous period of time. In some embodiments, the KPI value comprises a weighted sum of one or more KPI metrics measured based on interaction sessions between riders and the ride-hailing platform that occurred in the pricing unit during the previous period of time. In some embodiments, the one or more KPI metrics comprise at least one of the following: a trip conversion rate metric, a gross profit metric, a net income metric, a gross merchandise value (GMV) metric, or a gross booking metric.

Block 520 includes constructing a hash key based on (1) an identifier of the pricing unit and (2) the price multiplier.

Block 530 includes updating a hash table based on the KPI value and the hash key. In some embodiments, the updating a hash table comprises: determining whether the hash key exists in the hash table; when the hash key does not exist in the hash table, adding a new entry comprising the hash key and the KPI value into the hash table; and when the hash key exists in the hash table and corresponds to an existing KPI value, updating the existing KPI value based on the KPI value and a KPI decay rate. In some embodiments, the updating the existing KPI value based on the KPI value and a KPI decay rate comprises: determining a new KPI value based on a sum of (1) a first product of the existing KPI value and the KPI decay rate and (2) a second product of the KPI value and a complement of KPI decay rate; and replacing the existing KPI value with the new KPI value.

Block 540 includes determining whether to perform exploration or exploitation for a current period of time. In some embodiments, the determining whether to perform exploration or exploitation for a current period of time comprises: determining whether to perform exploration or exploitation for a current period of time based on a randomly generated number and an exploration rate. In some embodiments, when it is determined to perform exploitation, the method further comprise updating the exploration rate based on the determined new price multiplier.

Block 550 includes when it is determined to perform exploration, selecting a new price multiplier from a list of price multiplier candidates to apply to the pricing unit for the current period of time. In some embodiments, the selecting a new price multiplier from a list of price multiplier candidates to apply to the pricing unit for the current period of time comprises: determining whether a difference between the new price multiplier and the price multiplier is greater than a threshold; and when the difference is greater than the threshold, randomly selecting another new price multiplier from the list of price multiplier candidates.

Block 560 includes when it is determined to perform exploitation: determining the new price multiplier based on one or more entries in the hash table to apply to the pricing unit for the current period of time, wherein the one or more entries correspond to one or more price multipliers that have been previously applied to the pricing unit; and updating the exploration rate based on the new price multiplier. In some embodiments, the determining the new price multiplier based on one or more entries in the hash table comprises: identifying one of the one or more entries with the highest KPI value, wherein the one entry corresponds to an optimal price multiplier; and determining the optimal price multiplier as the new price multiplier. In some embodiments, the updating the exploration rate comprises: determining whether the new price multiplier is the same as a previous price multiplier that has been applied in the pricing unit during a most recent period time in which exploitation was performed; if the new price multiplier is the same as the previous price multiplier, adjusting the exploration rate based at least on an exploration decay rate; and if the new price multiplier is not the same as the previous price multiplier, resetting the exploration rate to a default value.

In some embodiments, the method 500 may further comprise adjusting a length of the current period of time. In some embodiments, the method 500 may further comprise for a newly created pricing unit to which no price multiplier has applied, determining the new price multiplier with a default value

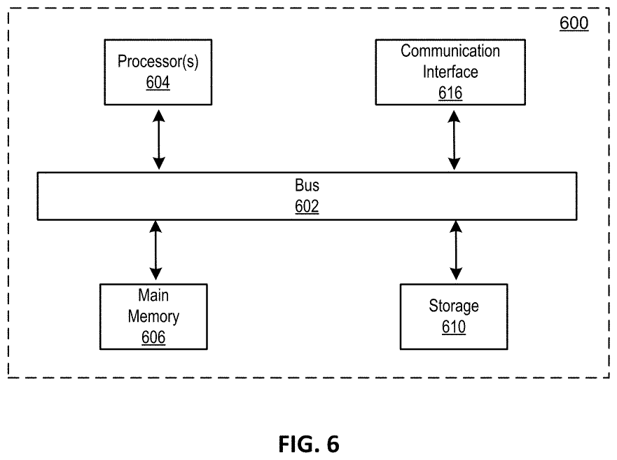

FIG. 6 illustrates an example computing device in which any of the embodiments described herein may be implemented. The computing device may be used to implement one or more components of the systems and the methods shown in FIGS. 1-5. The computing device 600 may comprise a bus 602 or another communication mechanism for communicating information and one or more hardware processors 604 coupled with bus 602 for processing information. Hardware processor(s) 604 may be, for example, one or more general-purpose microprocessors.

The computing device 600 may also include a main memory 606, such as a random-access memory (RAM), cache and/or other dynamic storage devices 610, coupled to bus 602 for storing information and instructions to be executed by processor(s) 604. Main memory 606 also may be used for storing temporary variables or other intermediate information during execution of instructions to be executed by processor(s) 604. Such instructions, when stored in storage media accessible to processor(s) 604, may render computing device 600 into a special-purpose machine that is customized to perform the operations specified in the instructions. Main memory 606 may include non-volatile media and/or volatile media. Non-volatile media may include, for example, optical or magnetic disks. Volatile media may include dynamic memory. Common forms of media may include, for example, a floppy disk, a flexible disk, hard disk, solid state drive, magnetic tape, or any other magnetic data storage medium, a CD-ROM, any other optical data storage medium, any physical medium with patterns of holes, a RAM, a DRAM, a PROM, and EPROM, a FLASH-EPROM, NVRAM, any other memory chip or cartridge, or networked versions of the same.

The computing device 600 may implement the techniques described herein using customized hard-wired logic, one or more ASICs or FPGAs, firmware and/or program logic which in combination with the computing device may cause or program computing device 600 to be a special-purpose machine. According to one embodiment, the techniques herein are performed by computing device 600 in response to processor(s) 604 executing one or more sequences of one or more instructions contained in main memory 606. Such instructions may be read into main memory 606 from another storage medium, such as storage device 610. Execution of the sequences of instructions contained in main memory 606 may cause processor(s) 604 to perform the process steps described herein. For example, the processes/methods disclosed herein may be implemented by computer program instructions stored in main memory 606. When these instructions are executed by processor(s) 604, they may perform the steps as shown in corresponding figures and described above. In alternative embodiments, hard-wired circuitry may be used in place of or in combination with software instructions.

The computing device 600 also includes a communication interface 616 coupled to bus 602. Communication interface 616 may provide a two-way data communication coupling to one or more network links that are connected to one or more networks. As another example, communication interface 616 may be a local area network (LAN) card to provide a data communication connection to a compatible LAN (or WAN component to communicate with a WAN). Wireless links may also be implemented.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each of the processes, methods, and algorithms described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

1. A computer-implemented method for determining price multipliers in a ride-hailing platform, the method comprising:
obtaining a price multiplier that has been applied in a pricing unit of the ride-hailing platform during a previous period of time and a key performance indicator (KPI) value of the pricing unit during the previous period of time;
constructing a hash key based on (1) an identifier of the pricing unit and (2) the price multiplier;
updating a hash table based on the KPI value and the hash key;
determining whether to perform exploration or exploitation for a current period of time;
when it is determined to perform exploration, selecting a new price multiplier from a list of price multiplier candidates to apply to the pricing unit for the current period of time; and
when it is determined to perform exploitation:
determining the new price multiplier based on one or more entries in the hash table to apply to the pricing unit for the current period of time, wherein the one or more entries correspond to one or more price multipliers that have been previously applied to the pricing unit.

2. The method of claim 1, wherein the determining the new price multiplier based on one or more entries in the hash table comprises:
identifying one of the one or more entries with the highest KPI value, wherein the one entry corresponds to an optimal price multiplier; and
determining the optimal price multiplier as the new price multiplier.

3. The method of claim 1, wherein the KPI value comprises a weighted sum of one or more KPI metrics measured based on interaction sessions between riders and the ride-hailing platform that occurred in the pricing unit during the previous period of time.

4. The method of claim 3, wherein the one or more KPI metrics comprise at least one of the following: a trip conversion rate metric, a gross profit metric, a net income metric, a gross merchandise value (GMV) metric, or a gross booking metric.

5. The method of claim 1, wherein the updating a hash table comprises:
determining whether the hash key exists in the hash table;
when the hash key does not exist in the hash table, adding a new entry comprising the hash key and the KPI value into the hash table; and
when the hash key exists in the hash table and corresponds to an existing KPI value, updating the existing KPI value based on the KPI value and a KPI decay rate.

6. The method of claim 5, wherein the updating the existing KPI value based on the KPI value and a KPI decay rate comprises:
determining a new KPI value based on a sum of (1) a first product of the existing KPI value and the KPI decay rate and (2) a second product of the KPI value and a complement of KPI decay rate; and
replacing the existing KPI value with the new KPI value.

7. The method of claim 1, wherein the selecting a new price multiplier from a list of price multiplier candidates to apply to the pricing unit for the current period of time comprises:
determining whether a difference between the new price multiplier and the price multiplier is greater than a threshold; and
when the difference is greater than the threshold, randomly selecting another new price multiplier from the list of price multiplier candidates.

8. The method of claim 1, wherein the determining whether to perform exploration or exploitation for the current period of time comprises:
determining whether to perform exploration or exploitation for the current period of time based on a randomly generated number and an exploration rate.

9. The method of claim 8, wherein the method further comprises:
determining whether the new price multiplier is the same as a previous price multiplier that has been applied in the pricing unit during a most recent period time in which exploitation was performed;
if the new price multiplier is the same as the previous price multiplier, adjusting the exploration rate based at least on an exploration decay rate; and
if the new price multiplier is not the same as the previous price multiplier, resetting the exploration rate to a default value.

10. The method of claim 1, further comprising:
adjusting a length of the current period of time.

11. The method of claim 1, further comprising:
for a newly created pricing unit to which no price multiplier has applied, determining the new price multiplier with a default value.

12. A system comprising one or more processors and one or more non-transitory computer-readable memories coupled to the one or more processors, the one or more non-transitory computer-readable memories storing instructions that, when executed by the one or more processors, cause the system to perform operations comprising:
obtaining a price multiplier that has been applied in a pricing unit of the ride-hailing platform during a previous period of time and a key performance indicator (KPI) value of the pricing unit during the previous period of time;
constructing a hash key based on (1) an identifier of the pricing unit and (2) the price multiplier;
updating a hash table based on the KPI value and the hash key;
determining whether to perform exploration or exploitation for a current period of time;
when it is determined to perform exploration, selecting a new price multiplier from a list of price multiplier candidates to apply to the pricing unit for the current period of time; and
when it is determined to perform exploitation:
determining the new price multiplier based on one or more entries in the hash table to apply to the pricing unit for the current period of time, wherein the one or more entries correspond to one or more price multipliers that have been previously applied to the pricing unit.

13. The system of claim 12, wherein the determining the new price multiplier based on one or more entries in the hash table comprises:
identifying one of the one or more entries with the highest KPI value, wherein the one entry corresponds to an optimal price multiplier; and
determining the optimal price multiplier as the new price multiplier.

14. The system of claim 12, wherein the updating a hash table comprises:
determining whether the hash key exists in the hash table;
when the hash key does not exist in the hash table, adding a new entry comprising the hash key and the KPI value into the hash table; and
when the hash key exists in the hash table and corresponds to an existing KPI value, updating the existing KPI value based on the KPI value and a KPI decay rate.

15. The system of claim 14, wherein the updating the existing KPI value based on the KPI value and a KPI decay rate comprises:
determining a new KPI value based on a sum of (1) a first product of the existing KPI value and the KPI decay rate and (2) a second product of the KPI value and a complement of KPI decay rate; and
replacing the existing KPI value with the new KPI value.

16. The system of claim 12, wherein the selecting a new price multiplier from a list of price multiplier candidates to apply to the pricing unit for the current period of time comprises:
determining whether a difference between the new price multiplier and the price multiplier is greater than a threshold; and
when the difference is greater than the threshold, randomly selecting another new price multiplier from the list of price multiplier candidates.

17. A non-transitory computer-readable storage medium storing instructions that, when executed by one or more processors, cause the one or more processors to perform operations comprising:
obtaining a price multiplier that has been applied in a pricing unit of the ride-hailing platform during a previous period of time and a key performance indicator (KPI) value of the pricing unit during the previous period of time;
constructing a hash key based on (1) an identifier of the pricing unit and (2) the price multiplier;
updating a hash table based on the KPI value and the hash key;
determining whether to perform exploration or exploitation for a current period of time;
when it is determined to perform exploration, selecting a new price multiplier from a list of price multiplier candidates to apply to the pricing unit for the current period of time; and
when it is determined to perform exploitation:
determining the new price multiplier based on one or more entries in the hash table to apply to the pricing unit for the current period of time, wherein the one or more entries correspond to one or more price multipliers that have been previously applied to the pricing unit.

18. The storage medium of claim 17, wherein the determining the new price multiplier based on one or more entries in the hash table comprises:
identifying one of the one or more entries with the highest KPI value, wherein the one entry corresponds to an optimal price multiplier; and
determining the optimal price multiplier as the new price multiplier.

19. The storage medium of claim 17, wherein the updating a hash table comprises:
determining whether the hash key exists in the hash table;
when the hash key does not exist in the hash table, adding a new entry comprising the hash key and the KPI value into the hash table; and
when the hash key exists in the hash table and corresponds to an existing KPI value, updating the existing KPI value based on the KPI value and a KPI decay rate.

20. The storage medium of claim 17, wherein the selecting a new price multiplier from a list of price multiplier candidates to apply to the pricing unit for the current period of time comprises:
determining whether a difference between the new price multiplier and the price multiplier is greater than a threshold; and
when the difference is greater than the threshold, randomly selecting another new price multiplier from the list of price multiplier candidates.
